(19) United States
(12) Patent Application Publication
(10) Pub. No.: US 2007/0089944 A1
(43) Pub. Date: Apr. 26, 2007

(54) Brake band assembly

(75) Inventor: Yoshihisa Harada, Fukuroi-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK-Warner K.K., Shinagawa-ku (JP)

(21) Appl. No.: 11/545,551

(22) Filed: Oct. 11, 2006

(30) Foreign Application Priority Data
Oct. 13, 2005 (JP) 2005-298413

(51) Int. Cl. F16D 51/00

(52) U.S. Cl. 188/77 W; 188/77 R

(57) ABSTRACT

A brake band assembly for use in a transmission is provided with a brake drum and a brake band arranged surrounding the brake drum and having a strap and a lining bonded on an inner surface of the strap. The brake band assembly includes an antitilt device for the brake band. The antitilt device is arranged on the brake band such that, when the brake band assembly is out of operation, the lining of the brake band is kept out of contact with the brake drum.

### FIELD OF THE INVENTION

This invention relates to a brake band assembly useful in various transmissions such as automatic transmissions.

### DESCRIPTION OF THE BACKGROUND

When holding a sun gear and/or a ring gear against rotation in a transmission such as an automatic transmission that makes use of planetary gears, a brake band assembly (brake band assemblies) are used as device(s) for holding the rotating member(s) against rotation.

FIG. 1 is a front view of a brake band assembly 10. A brake band 20 which surrounds a brake drum (not shown) is provided at opposite ends thereof with an apply bracket 30 for applying a binding load and an anchor bracket 40 for receiving a reaction force, respectively. FIG. 1 also illustrates a pressing portion 34 for applying a load to the apply bracket, a support member 41 for receiving a reaction force exerted on the anchor bracket, and a casing 60 accommodating said brake band assembly 10 therein.

The brake band 20 is composed of a strap 21, on which the brackets are secured, and a lining 22 bonded on an inner surface of the strap 21 such that the lining 22 can be brought into contact with the brake drum. The apply bracket 30 and anchor bracket 40 are positioned by an apply pin and anchor pin (not shown) fixed on the casing 60.

In general, the respective load-receiving portions of the bake band and the above-mentioned, corresponding pins are not fixed together but are held in contact with each other with a play. For the prevention of burning or wearing of the lining of the brake band and for the reduction of a drag torque upon idling between the brake band and the brake drum, it is desired to maintain a clearance between the brake drum and the lining of the brake band when the brake band assembly is out of operation.

The brake bandmay, however, tilt in an axial direction because the brake band and the pins are in contact with each other with a play as mentioned above. Referring to FIG. 2 which is a side view of the brake band assembly of FIG. 1 as viewed in a direction F, the brake band 20 surrounding a brake drum 50 therein is secured to the corresponding brackets at bracket securing portions located at opposite ends of the strap 21. Numeral 51 indicates a hub of the brake drum. Although the brake band 20 is positioned by the apply pin and anchor pin, the brake band 20 and these pins are in contact with each other with a play. In the course of an operation, the brake band 20 may hence tilt as shown in the drawing so that the lining 22 may be brought into contact with the brake drum 50, causing an increase in idling drag and burning and wearing of the lining 22 and brake drum 50.

When a rotation axis X-X of the brake drum 50 is horizontal as depicted in FIGS. 1 and 2, there is a possibility that the brake band 20 may tilt in the course of an operation as mentioned above. When a brake band assembly is used with the rotation axis X-X of its brake drum 50 extending in a vertical direction as shown in FIG. 7 onwards to be described subsequently herein, the brake band 20 tilts by its own weight and the formation of an oil film between the brake drum 50 and the lining 22 of the brake band is insufficient. The tilted edge portion of the lining 22, therefore, is brought into contact with the brake drum 50, causing burning and wearing of the lining and brake drum.

It is to be noted that FIGS. 1 and 2 also illustrate a thrust receiving surface 31 of the apply bracket 30, staking pins 32, and a recess 33 for supporting the apply pin (the anchor bracket 40 has a similar construction).

### SUMMARY OF THE INVENTION

As a result of an extensive investigation, the present inventor has found that the above-described drawbacks of the conventional brake band assembly can be overcome by providing its brake band with an antitilt device. In one aspect of the present invention, there is thus provided a brake band assembly for use in a transmission, said brake band assembly being provided with a brake drum and a brake band arranged surrounding the brake drum and having a strap and a lining bonded on an inner surface of the strap. The brake band assembly, comprises an antitilt device for the brake band, and the antitilt device is arranged on the brake band such that, when the brake band assembly is out of operation, the lining of the brake band is kept out of contact with the brake drum.

Owing to the above-described construction, the present invention makes it possible to prevent, with a simple structure, a tilt of the brake band, an increase in idling drag and burning and wearing of the brake drum and linings during non-operation of the brake band assembly. Especially when the brake band assembly is used with a rotation axis of its brake drum being kept in a vertical direction, a tilt under its own weight is prevented from the beginning, thereby making it possible to provide a brake band assembly the performance of which is stable.

### BRIEF DESCRIPTION OF THE DRAWINGS

FIG. 1 is a front view of a brake band assembly.

FIG. 2 is a partly-sectional side view of the brake band assembly, and shows a brake band in a tilted state.

FIG. 3 is a partly-sectional side view of a brake band assembly according to a first embodiment of the present invention.

FIG. 4 is a top plan view of a strap in the brake band assembly of FIG. 3.

FIG. 5 is a partly-sectional side view of a brake band assembly according to a second embodiment of the present invention.

FIG. 6 is a top plan view of a strap in the brake band assembly of FIG. 5.

FIG. 7 is a partly-sectional side view of a brake band assembly according to a third embodiment of the present invention.

FIG. 8 is a front view of a strap in the brake band assembly of FIG. 7.

FIG. 9 is a partly-sectional side view of a brake band assembly according to a fourth embodiment of the present invention.

FIG. 10 is a front view of a strap in the brake band assembly of FIG. 9.

FIG. 11 is a partly-sectional side view of a brake band assembly according to a fifth embodiment of the present invention.

FIG. 12 is a partly-sectional side view of a brake band assembly according to a sixth embodiment of the present invention.

### DETAILED DESCRIPTION OF THE INVENTION AND PREFERRED EMBODIMENTS

To overcome the above-described drawback of the conventional brake band assembly, an antitilt portion may be formed on an edge face of the strap of the brake band, or a discrete antitilt portion may be arranged on a surface of the strap of the brake band.

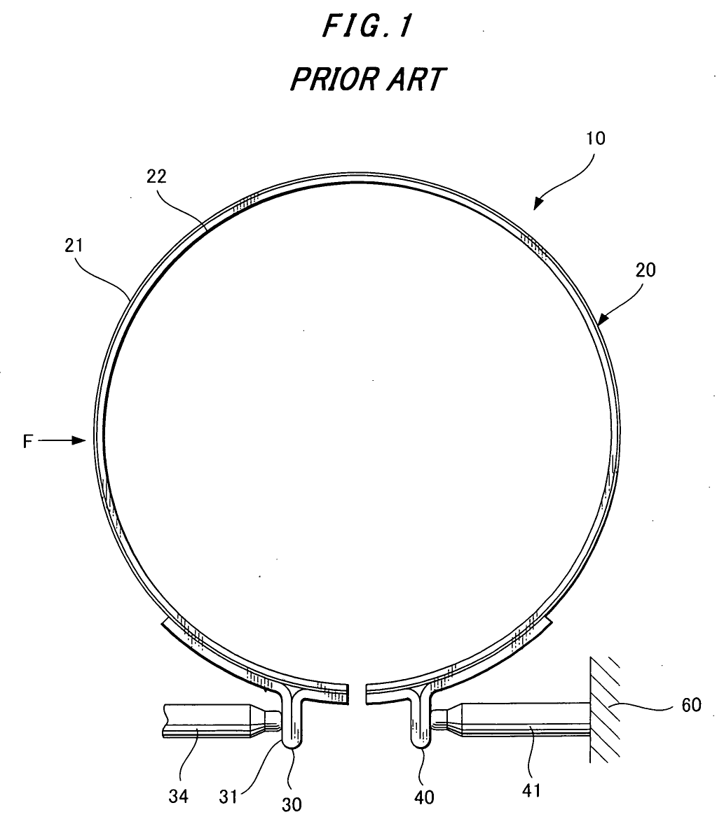

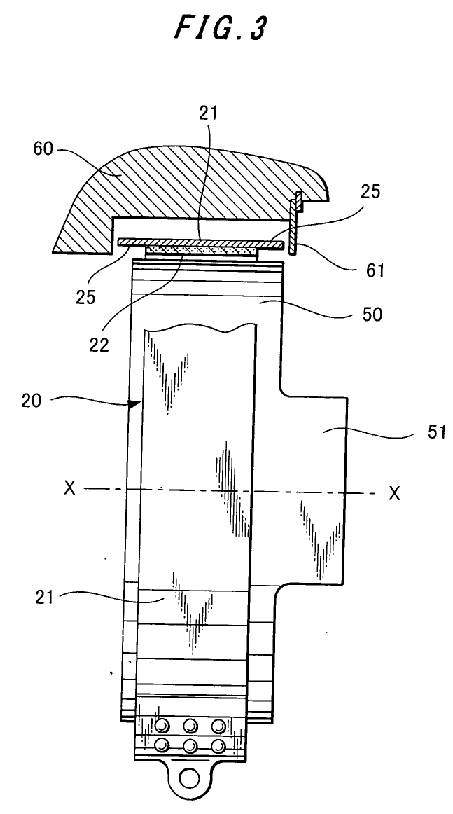

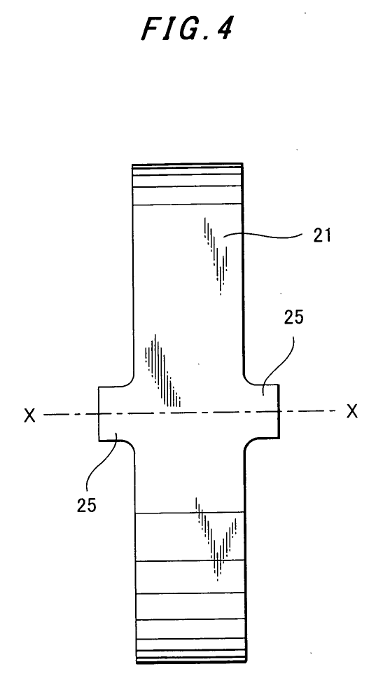

FIG. 3 is a partly-sectional side view of a brake band assembly according to the first embodiment of the present invention, and FIG. 4 is a view of a strap 21 in the brake band assembly as viewed at a top surface thereof. In this embodiment, a brake band 20 surrounds the brake drum 50 arranged with its rotation axis X-X extending horizontally. At a central part of the strap 21 between the apply bracket 30 and the anchor bracket 40 (see FIG. 1), both edge faces of the strap are outwardly extended as much as desired to form antitilt portions 25.

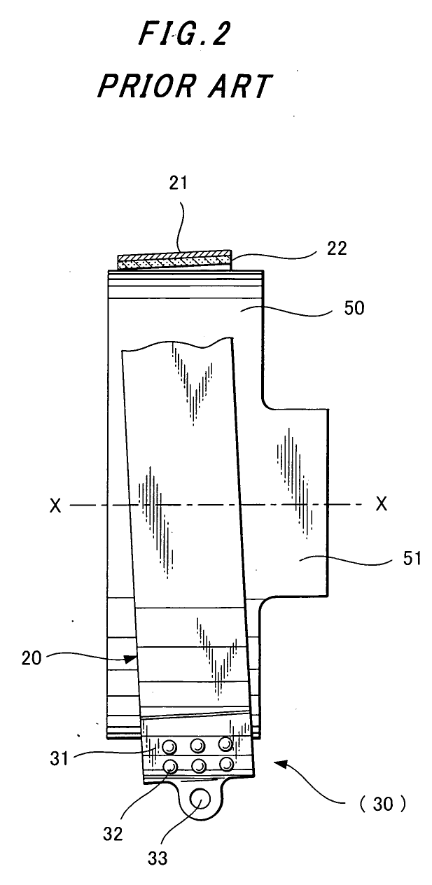

In FIG. 3, numeral 61 indicates a limiting plate arranged on the casing 60. From the standpoints of reducing an idling drag and also preventing the lining 22, brake drum 50 and the like from burning and wearing, it is desired to maintain a clearance between the lining 22 and the brake drum 50 while the band brake assembly is out of operation. There is, however, a possibility that the brake band 20 may tilt for a certain reason to bring the lining 22 and the brake drum 50 into contact as shown in FIG. 2. In this embodiment, the right-side antitilt portion 25 is checked by the limiting plate 61 when the brake band 20 begins to tilt rightwards as viewed in FIG. 3, and the left-side antitilt portion 25 is checked by the casing 60 when the brake band 20 begins to tilt leftwards as viewed in FIG. 3. As a consequence, the brake band 20 is prevented from tilting. Designated at numeral 51 is the hub of the drum 50.

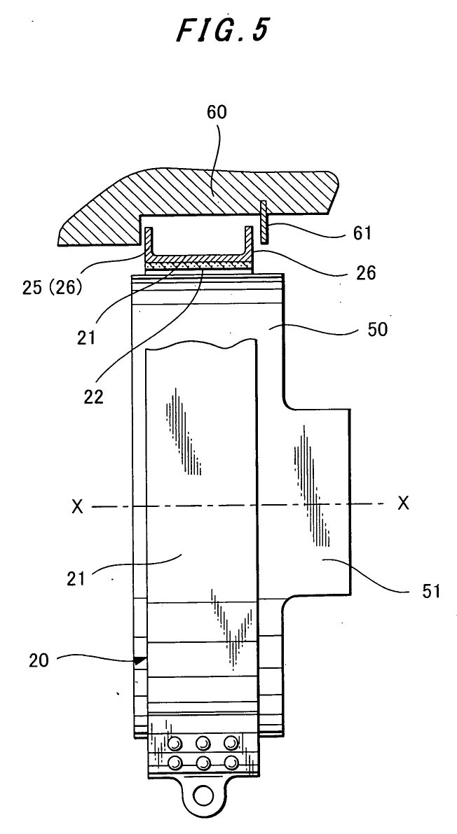

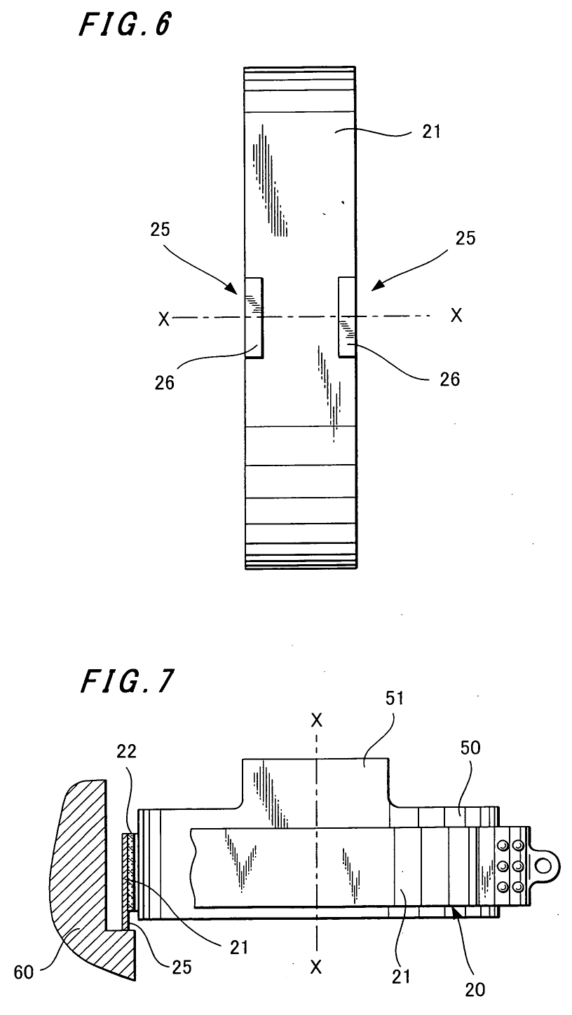

FIG. 5 is a partly-sectional side view similar to FIG. 3 and illustrates a brake band assembly according to the second embodiment, and FIG. 6 is a top plan view of a strap 21 in the brake band assembly. In FIGS. 5 and 6, those parts of the brake band assembly which are the same as or equivalent to corresponding parts in FIGS. 3 and 4 are shown by the same reference numerals. In this second embodiment, antitilt portions 25 are formed as bent portions 26 by bending portions of the strap 21, said portions extending outwardly, at right angles. When the brake band 20 begins to tilt in this second embodiment, one of the left and right bent portions 26 is checked by a limiting plate 61 or the casing 60 so that the brake band 20 is preventing from tilting.

On each of the edge faces of the strap 21, plural antitilt portions 25, in other words, bent portions 26 may be arranged at suitable positions, respectively, instead of arranging only one antitilt portion 25, in other words, bent portion 26 at a central position between the apply bracket and the anchor bracket.

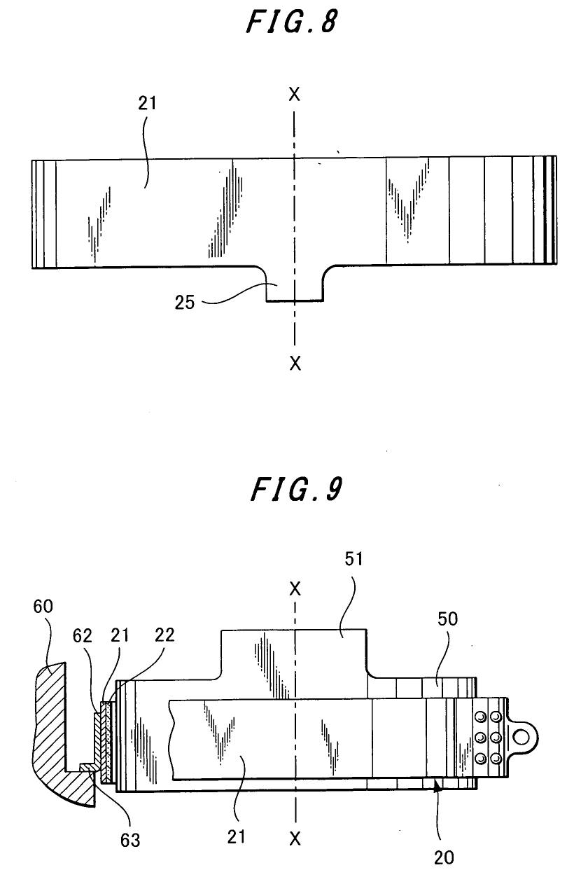

FIG. 7 is a partly-sectional side view of a brake band assembly according to the third embodiment when the brake drum is arranged with its rotation axis X-X extending in a vertical direction, and FIG. 8 is a front view of a strap 21 in the band brake assembly. In FIGS. 7 and 8, those parts of the brake band assembly which are the same as or equivalent to corresponding parts in FIGS. 1 through 6 are shown by the same reference numerals. As the rotation axis X-X of the brake drum 50 vertically extends in this embodiment, a downward force is normally applied to a brake band 20. Accordingly, an antitilt portion 25 is formed on a lower edge face of the strap 21 and is checked by a casing 60.

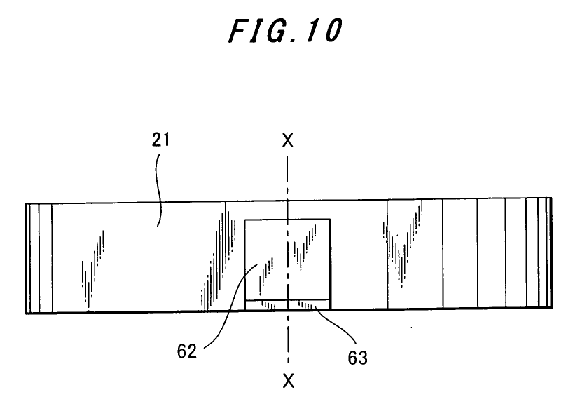

FIGS. 9 and 10 illustrate a brake band assembly according to the fourth embodiment, and are similar to FIGS. 7 and 8, respectively. In this embodiment, a discrete antitilt portion 61 is arranged on a strap 21 instead of forming an antitilt portion on an edge face of the strap. A bent portion 63 is formed on a lower end of the antitilt portion 62, and this bent portion 63 is checked by the casing 60 to prevent the whole brake band 20 from tilting downwards.

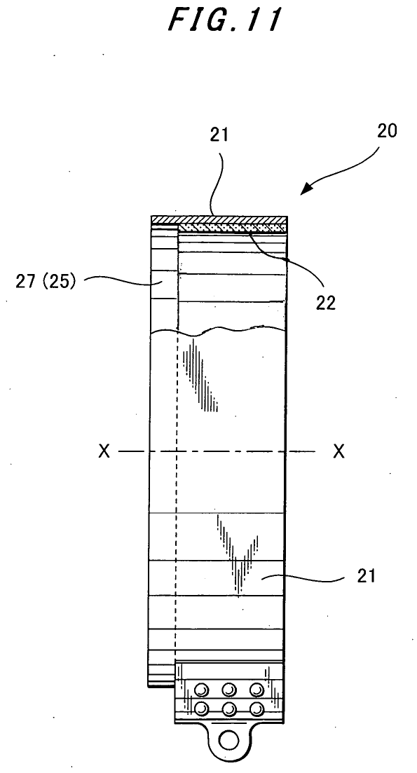

In each of the above-described embodiments, the antitilt portion(s) are formed at a portion or portions of the strap. From the standpoint of facilitating the manufacture, however, it is advantageous to form the strap broader than the lining and to employ a portion of the strap, said portion outwardly extending beyond the lining and being to be called “a rim”, as an antitilt portion. FIG. 11 is a partly cut-away, side view of a strap 21 in a band brake assembly according to the fifth embodiment. A lining 22 is bonded to the strap 21 such that the strap 21 includes, on and along one of its side faces, a rim 27 by which the strap 21 is greater in width than the lining 22. This rim 27 performs the action of as the antitilt portions in the first to fourth embodiments.

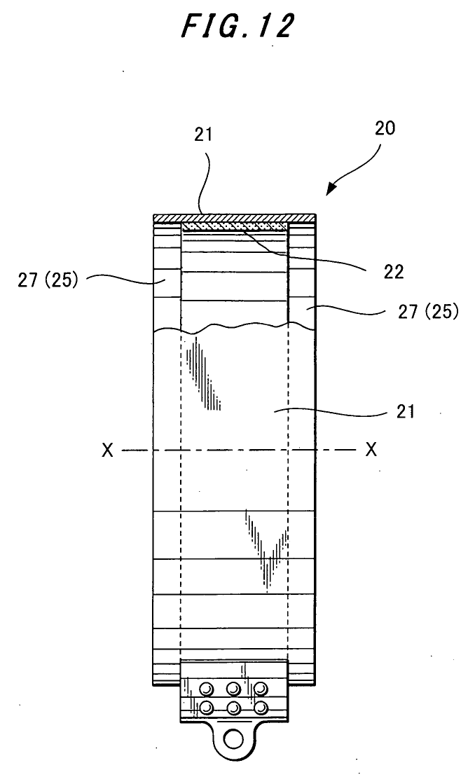

FIG. 12 is a partly-sectional side view of a brake band assembly according to the sixth embodiment. In this embodiment, a brake band 20 is constructed such that a strap 21 includes rims 27 on both sides of a lining 22.

The present invention contributes to an increase in the service life of a brake band and also to improvements in the stability of performance of a brake band assembly. Especially when a brake drum is arranged with its rotation angle extending vertically, a downward force is normally applied to the brake band. The use of the present invention in such a situation makes it possible to provide a brake band assembly the performance of which is very stable.

This application claims the priority of Japanese Patent Application 2005-298413 filed Oct. 13, 2005, which is incorporated herein by reference.

1. A brake band assembly for use in a transmission, said brake band assembly being provided with a brake drum and a brake band arranged surrounding said brake drum and having a strap and a lining bonded on an inner surface of said strap, comprising:
an antitilt device for said brake band, said antitilt device being arranged on said brake band such that, when said brake band assembly is out of operation, said lining of said brake band is kept out of contact with said brake drum.

2. A brake band assembly according to claim 1, wherein said antitilt device for said brake band is an antitilt portion arranged on an edge face of said strap of said brake band.

3. A brake band assembly according to claim 2, wherein said antitilt portion is arranged at a position substantially opposite to an anchor bracket and an apply bracket relative to a direction of circumference of said brake band.

4. A brake band assembly according to claim 2, further comprising another antitilt portion arranged on an opposite edge face of said strap of said brake band at the same circumferential position as said antitilt portion.

5. A brake band assembly according to claim 4, wherein said antitilt portions are arranged at positions substantially opposite to an anchor bracket and an apply bracket relative to a direction of circumference of said brake band.

6. A brake band assembly according to claim 1, wherein said antitilt device for said brake band comprises antitilt portions arranged on an edge face of said strap of said brake band at plural positions, respectively, relative to a direction of circumference of said brake band.

7. A brake band assembly according to claim 1, wherein said antitilt device for said brake band is a discrete antitilt portion arranged on a surface of said strap of said brake band.
